(19) United States
(12) Patent Application Publication
(10) Pub. No.: US 2005/0013249 A1
(43) Pub. Date: Jan. 20, 2005

(54) Redundant packets for streaming video protection

(76) Inventors: Hao-Song Kong, Auburndale, MA (US); Huai-Rong Shao, Cambridge, MA (US); Anthony Vetro, Cambridge, MA (US); Huifang Sun, Cambridge, MA (US)

Correspondence Address: MITSUBISHI ELECTRIC INFORMATION;TECHNOLOGY CENTER AMERICA, 8TH FLOOR, 201 BROADWAY, CAMBRIDGE, MA, 02139, US

(21) Appl. No.: 10/619,358

(22) Filed: Jul. 14, 2003

(51) Int. Cl. H04L 12/28

(52) U.S. Cl. 370/235; 714/748

(57) ABSTRACT

A method transmits a video over a network as a bit stream of packets. Real-time feedback information on conditions of the network is received while transmitting the packets. A probability of packet loss is based on the real-time feedback. Then, redundant packets are generated for selected packets of the bit stream if the probability of packet loss is greater than a predetermined threshold.

### FIELD OF THE INVENTION

The invention relates generally to streaming multimedia over communications networks, and more particularly to streaming real-time video over packet networks.

### BACKGROUND OF THE INVENTION

In the recent years, there has been an increasing demand for the capability to stream real-time multimedia content, e.g., videos, over packet networks, the Internet. However, up to now, real-time video on the Internet has not been widely used because the Internet uses only best-effort for delivering packets. Best effort means that packets can be lost, and received packet may not be in the correct order. This continues to be a problem.

Common solutions include an automatic repeat-request (ARQ) mechanism and an interleaving technique. The ARQ mechanism allows the receiver to request the sender to retransmit the lost packets, see U.S. Pat. No. 6,289,054, “Method and systems for dynamic hybrid packet loss recovery for video transmission over lossy packet-based network,” issued to Rhee on Sep. 11, 2001. However, in practical applications, the latency requirements do not permit retransmission of all lost packets.

The interleaving technique scrambles transmitted packets so that isolated packet losses can be reconstructed from surviving neighboring packets, see U.S. Pat. No. 6,247,150, “Automatic retransmission with order of information changed,” issued to Nielema on Jun. 12, 2001. The interleaving technique minimizes perceptual damage caused by the packet loss, but does not recover the critical information in the bit stream. Due to the large size of video frames, a simple interleaving technique is not effective for the packet loss problem.

Prior art packet loss recovery techniques can be divided into two classes: active retransmission and passive channel coding, see Perkins et al., “A survey of packet-loss recovery techniques for streaming audio,” IEEE Network Magazine, September/October 1998, Sze et al., “A packet-loss-recovery scheme for continuous-media streaming over the Internet,” IEEE Communications letters, Vol. 5, No. 3, March 2001, and Feamster et al. “Packet loss recovery for streaming video”, International Packet Video Workshop, Pittsburgh, Pa., USA, April 2002.

For the active retransmission technique to be successful, a retransmitted packet must arrive at the receiver in time for playback. Otherwise, the retransmission simply wastes bandwidth. Generally, retransmission has been considered inappropriate for real-time streaming data because of the delays.

For the passive channel coding techniques, there are traditional forward error correction (FEC) schemes. The FEC schemes rely on the addition of redundant bits to the stream to recover lost data. A large number of FEC codes are known, however, FEC schemes do not consider the structure of the underlying data content.

FIG. 1 shows a prior art video streaming system 100 including a sender subsystem and a receiver subsystem 120 connected by a packet network 130. The sender subsystem includes an information source module 111, a source encoder module 112, a packetizer module 113, a redundancy encoder module 114, and a RTP/UDP module 115. The receiver subsystem comprises a UDP/RTP module 125, an error detection/correction module 124, a depacketizer module 123, a source decoder module 122, and a destination module 121.

The information source module generates digitized video information by performing digital sampling on a video signal generated by a video camera. The source encoder module encodes the digitized video information by performing data compression, e.g., MPEG 2/4 or H0.26X, and outputs a digital video bit stream to the packetizer module. In the packetizer module, the video bit stream is partitioned into packets, in such a way that the packets can be transmitted one by one over the communication networks 130. Because the packets are often corrupted by network noise, redundancies are added to the packets so that the errors can be detected and corrected in the receiver. The encoded packets are transmitted over the communication networks through the RTP/UDP module.

On the receiver subsystem side, the UDP/RTP passes the received packets to the error detection/correction module. The error detection/correction module utilizes the redundancy information embedded in the packets to detect and correct errors. If the error cannot be corrected, a retransmit request 140 is sent to the sender. The packets are depacketized and assembled into the bit stream to be decoded for the destination.

As stated earlier, the retransmission mechanism is infeasible for Internet streaming because the retransmission of lost packet takes at least one additional round-trip time, which may be too much latency for the streaming applications. In addition, the redundancy encoding reduces much of the compression gains because every packet is redundantly encoded.

Therefore, there is a need for a method and system that improves the delivery of streaming multimedia over a packet network, such as the Internet.

### SUMMARY OF THE INVENTION

Packet loss has been a major problem in multimedia streaming on the Internet. The invention provides a simple and efficient method for packet loss recovery.

By protecting the most important packets in the bit stream, significant performance gains can be achieved without much increase in overhead.

The method according to the invention can also be applied to third generation (3G) wireless networks.

The method provides considerable reduction in complexity of packets retransmission. The invention distinguishes over prior art techniques because it examines and analyzes the structure of the bit stream and adds redundant packets for only packets that are more important.

### BRIEF DESCRIPTION OF THE DRAWINGS

FIG. 1 is a block diagram of a prior art video streaming system;

FIG. 2 is a block diagram of a method for video streaming according to the invention;

FIG. 3 is a block diagram of video encoding as packets according to the invention;

FIG. 4 is a block diagram of bit stream recovery using redundant packets according to the invention; and

FIG. 5 is a block diagram of a packet sequence in one group of frames.

### DETAILED DESCRIPTION OF THE PREFERRED EMBODIMENT

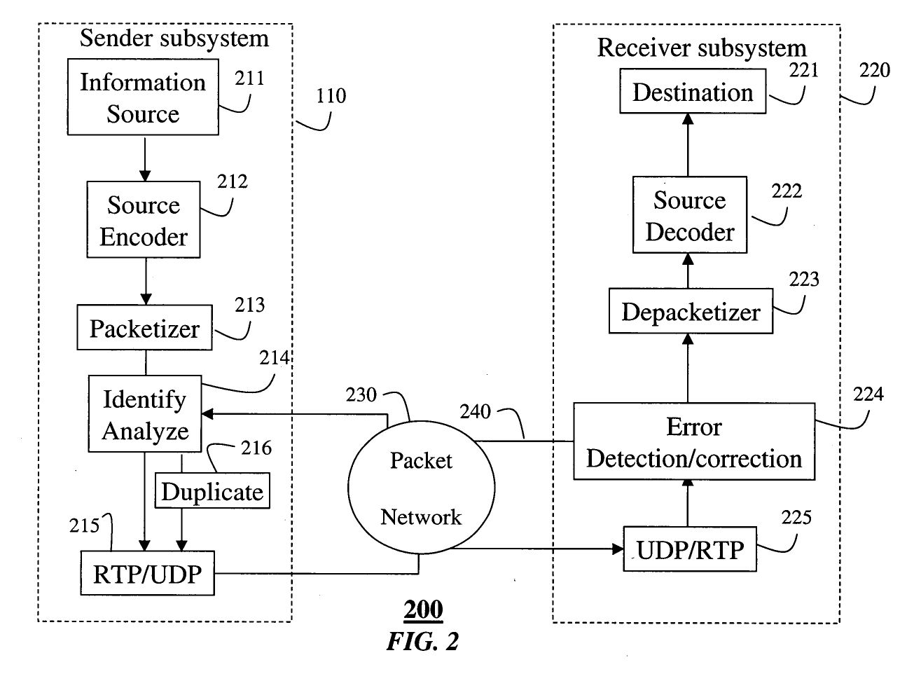

FIG. 2 shows a method and system 200 for streaming multi-media content, e.g., a video, over a packet network, such as the Internet with redundant packets according to the invention. The redundant packets minimize the effect of packet loss in a network that uses a best-effort delivery strategy.

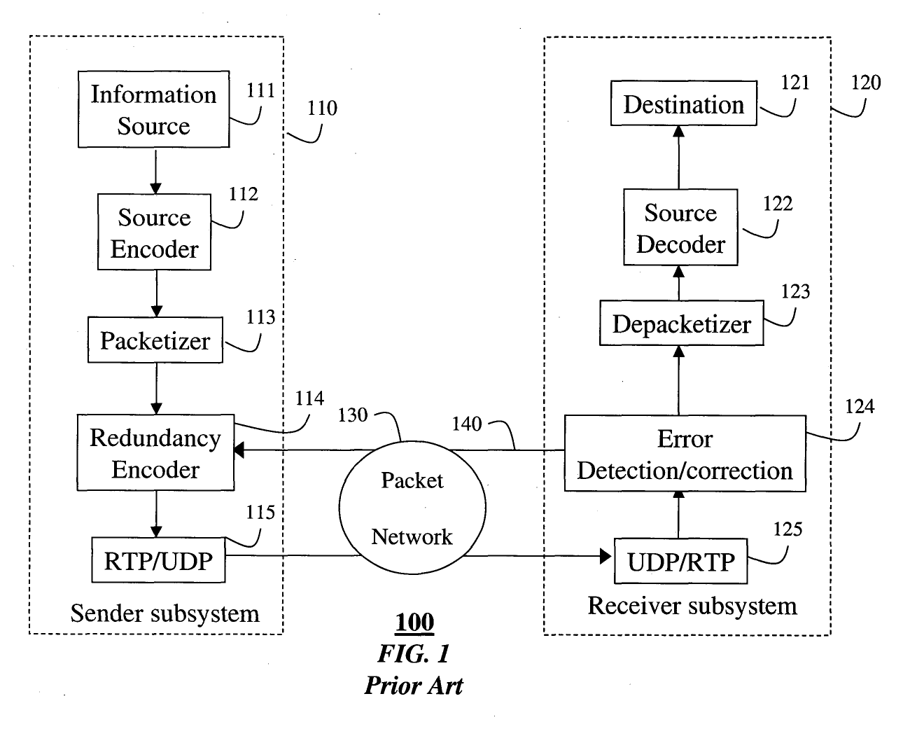

In contrast with prior art video streaming systems as shown in FIG. 1, the system according to the invention determines whether or not to add redundant packets to the bit stream in terms of network conditions to provide an optimal streaming solution with lower complexity.

The system 200 includes a sender subsystem 210 and receiver subsystem 220. The sender subsystem 210 includes an information source module 211, a source encoder module 212, a packetizer module 213, and a RTP/UDP module 215. The sender subsystem also includes an identify/analyze module 214 and a duplicate module 216.

The receiver subsystem 220 includes a UDP/RTP module 225, an error detection/correction module 224, a depacketizer module 223, a source decoder module 222, and a destination module 221.

The identify/analyze module 214 receives feedback information on conditions of the network 130. For example, RTCP reports 214 indicate conditions such as packet loss rate, available bandwidth, round-trip latency, see Friedman et al., “RTP Control Protocol Extended Reports (RTCP XR),” Internet Engineering Task Force (IETF), Audio/Video Transport Working Group, May 2003. The feedback information is used to determine a probability of packet loss. If the probability of packet loss is greater than a predetermined threshold, duplicate packets 216 are generated for selected packets of the bit stream.

The receiver uses the redundant packets to recover corrupted packets and to prevent the error propagation. The sender subsystem adaptively and selectively adds redundant packets to the bit streams in accordance with the received RTCP feedback information 240.

In an MPEG-4 bit stream, encoded I-frames are more important than encoded P-frames because P-frames can be coded using directional motion-compensated prediction from previous I- or P- frame. P-frames are more important than B-frames because B-frames are coded using only predictions from either past or future I- or P-frames. Thus, P-frames can be recovered from I-frames, and B-frames can be recovered form P-frames and I-frames.

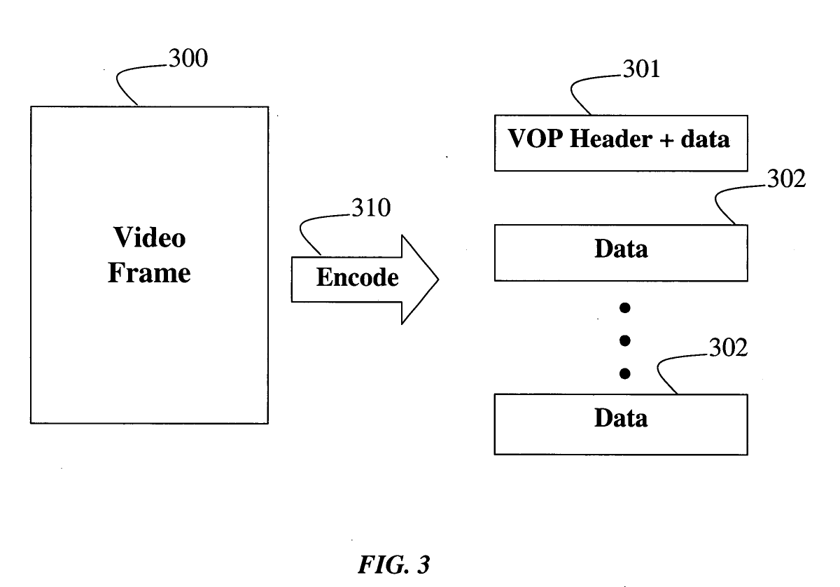

As shown in FIG. 3 according to the fragmentation rule of MPEG-4 video stream in RFC 3016, each video frame 300 is encoded 310 as a video object plane (VOP) header and data 301 the first packet, and subsequent data packets 302. Because the first packet contains information for reconstructing the frame, it is more important than other packets. The following describes the packet loss scenarios during the transmission.

If the first packet of the I-frame is lost, then the entire frame is damaged, and subsequent P- or B-frames will also have severe degradation. If other packets in I- or P-frame are lost, then that frame is degraded and the error is propagated to other frames. If the first packet in the B-frame is lost, then that frame is lost. If other packets in the B-frame are lost, then that B-frame is degraded, but the error is not propagated to other frames.

Therefore, the quality of the video is best protected when packets that can cause the greatest amount of degradation are sent more than once. Sending duplicate packets decreases the likelihood that all copies of that packet will be lost. Therefore, the receiver is likely to recover at least one of the redundant packets. Because the header packet in I- or P-frames plays an important role for reconstructing a current frame and stopping error propagation for the subsequent frames, two methods for adding redundant packets to the bit streams are provided by the invention.

In a first method, redundant packets are generated according to the frame type and their position in the frame. For instance, the first packets from each I-frame and some P-frames are duplicated as redundant packets due to their important features motioned above.

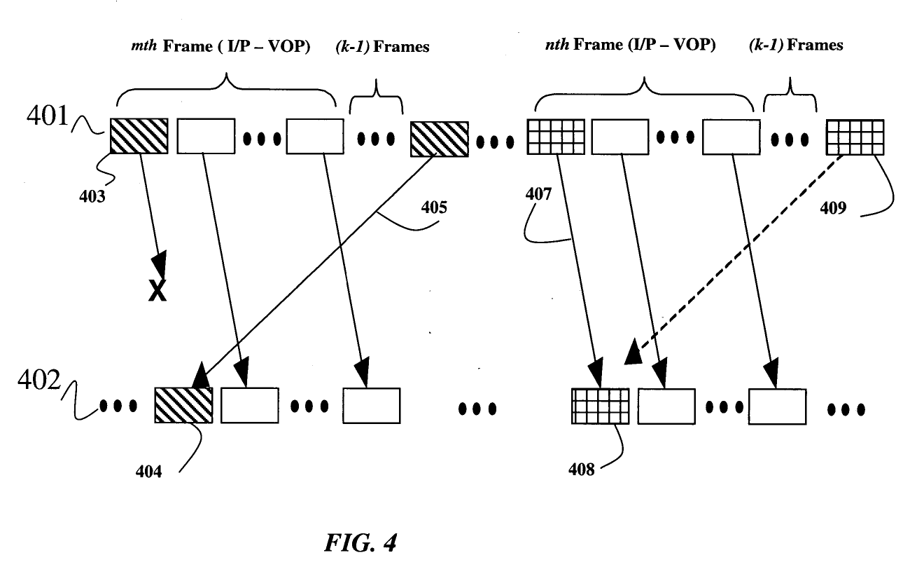

As shown in FIG. 4, redundant packets are sent to the receiver after some intervening packets have been sent. If there is no packet loss, the receiver simply discards the received redundant packet. When a packet loss occurs, especially when the VOP header packet is lost, the receiver uses one of the redundant packets to reconstruct the corresponding frames. For instance, the transmitter sends packets 401, and the receiver receives packets 402. Packets 403 and 405 are identical, as are packets 407 and 409 are identical. Packets 405 and 409 are redundant header packets of header packets 403 and 407. Packet 403 is lost and recovered from packet 405. Packet 408 is received, and packet 409 is discarded.

In order to reduce the network overhead, a second method includes header packets of I- and P-frames within a group of picture (GOP) into a larger redundant packet. Each GOP has one I-frame and K number of P-frames and L number of B-frames. The headers of I-frame and (N−1) P-frames are copied from the compressed bit stream into the redundant packet (N≦K+1). (N−1) P-frames are selected according to their importance to the video sequence. The total amounts of N frame headers is less than a network maximum transmission unit (MTU).

To satisfy the video playback requirement, the redundant header packet of a GOP is transmitted before the I-frame packet is transmitted. At the receiver, the redundant header is stored temporally. If some frame headers of the same GOP are lost or corrupted, then the redundant header packet can be used to recover the corrupted or missed frame headers. After all frames in the same GOP have been received, the redundant header packet can be deleted.

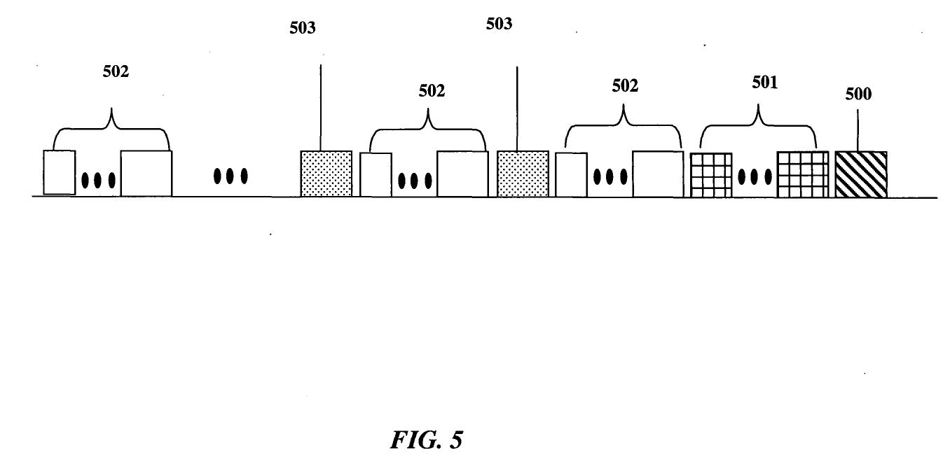

FIG. 5 shows packet sequence for one GOP. The sequence includes a redundant header packet 500, and I-frame 501, P-frame 502, and B-frame 503 packets. Each frame can be packetized to multiple packets or a single packet according to its size.

The redundant VOP header packets enable the recovery of VOP header packets, and allow the reconstruction of subsequent frames. Without the redundant packets, subsequent received packets become useless because the receiver cannot reconstruct them without header information. Combining the interleaving mechanism with the header packet protection methods in the sender subsystem, the receiver can recover lost frames due to header loss and repair damage caused by lost packets that are not containing the header information.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

1. A method for transmitting a video over a network as a bit stream of packets, comprising:
receiving real-time feedback information on conditions of the network while transmitting the packets;
determining a probability of packet loss based on the real-time feedback;
generating redundant packets for selected packets of the bit stream if the probability of packet loss is greater than a predetermined threshold.

2. The method of claim 1, in which the conditions include packet loss rate, available bandwidth, and round-trip latency.

3. The method of claim 1, in which the selected packet is a header packet of an I-frame.

4. The method of claim 1, in which the selected packet is a header packet of an P-frame.

5. The method of claim 1, in which the redundant packet is transmitted before an original copy of the corresponding packet.

6. The method of claim 1, in which the redundant packet is generated according to a frame type and a position of the original packet in the frame, and the redundant packet is transmitted after an original copy of the corresponding packet.
